(19) United States
(12) Patent Application Publication
(10) Pub. No.: US 2018/0095348 A1
(43) Pub. Date: Apr. 5, 2018

(54) LIGHT CONVERSION DEVICE, LIGHT SOURCE APPARATUS, AND PROJECTOR

(71) Applicant: SONY CORPORATION, TOKYO (JP)

(72) Inventor: YOSHIRO ASANO, KANAGAWA (JP)

(21) Appl. No.: 15/569,609

(22) PCT Filed: Apr. 19, 2016
(86) PCT No.: PCT/JP2016/062309

§ 371 Date: Oct. 26, 2017

(30) Foreign Application Priority Data
May 15, 2015 (JP) 2015-099921

(51) Int. Cl. G03B 21/16; F21V 29/74; F21V 29/67; F21K 9/64; G03B 21/20

(52) U.S. Cl. CPC G03B 21/16; F21V 29/74; G03B 21/208; F21K 9/64; G03B 21/204; F21V 29/677

(57) ABSTRACT

A light conversion device of the disclosure includes a heat dissipation substrate having a surface that is provided with a phosphor, and a plurality of heat dissipation fins that are attached to the heat dissipation substrate and rotate together with the heat dissipation substrate by causing a cooling medium to pass therethrough.

### TECHNICAL FIELD

The disclosure relates to a light conversion device and a light source apparatus each provided with a phosphor that converts a wavelength of light, and to a projector.

### BACKGROUND ART

In recent years, the number of products has been increased that adopt not existing high-pressure mercury lamps, xenon lamps and so forth but solid-state light emitting elements such as light emitting diodes (LEDs) and laser diodes (LDs) as light sources used in projectors and so forth for a presentation and a digital cinema. The solid-state light emitting element such as the LED is more advantageous than a discharge lamp in terms of not only size and power consumption but also high reliability. Above all, it is effective to increase light utilization efficiency by using the LD that is a point light source in order to achieve further luminance heightening and power consumption reduction.

The one that excites a phosphor that is formed on a rotating base with laser light emitted from the LD and utilizes fluorescence generated by the excitation is being developed as the projector that uses the LD as the light source. In such a projector, it is necessary to suppress a rise in temperature for temperature characteristics of light conversion efficiency of the phosphor and heat resisting property of a binder and so forth used for formation of the phosphor on the base. Therefore, for example, PTL 1 discloses a projector in which a phosphor wheel device to which a phosphor wheel on which a phosphor layer is formed and that is rotationally driven by a motor is attached and a blower that sends cooling air to a light emitting section of the phosphor layer are contained in an airtight container. An air circulation path is provided in the airtight container such that air from the blower flows to the light emitting section of the phosphor wheel.

### CITATION LIST

### Patent Literature

PTL 1: Japanese Unexamined Patent Application Publication No. 2014-92599

### SUMMARY OF INVENTION

The above-described structure of extracting fluorescence by irradiating the phosphor wheel with excitation light typically involves rotational use of the phosphor wheel using a spindle motor in order to diffuse heat density. In a situation of high output of the excitation light, a Sirocco fan, for example, is used to blow air for cooling in some types, in order to improve decrease in the light conversion efficiency due to temperature quenching. Further, in the situation of high output of the excitation light, the wheel rotation and the forced air cooling are not enough as cooling capabilities, and thus the phosphor wheel is provided with a cooling fin to enhance the cooling capabilities in some cases.

In a case of adopting a method of rotating the phosphor wheel using the spindle motor, it is difficult to use a heat sink securing sufficient surface area or a material such as copper having high thermal conductivity and a large specific weight due to weight limitation of the spindle motor. Further, it may be necessary to have a heat-insulated structure due to conduction of heat to the spindle motor. Moreover, there may be occurrence of an unusual high-frequency noise from the spindle motor.

It is desirable to provide a light conversion device and a light source apparatus that allow for cooling of heat generated in a phosphor without a motor, and a projector.

A light conversion device according to an embodiment of the disclosure includes a heat dissipation substrate having a surface that is provided with a phosphor, and a plurality of heat dissipation fins that are attached to the heat dissipation substrate and rotate together with the heat dissipation substrate by causing a cooling medium to pass therethrough.

A light source apparatus according to an embodiment of the disclosure includes a light conversion device and a light source section that emits excitation light toward the light conversion device. The light conversion device includes a heat dissipation substrate having a surface that is provided with a phosphor, and a plurality of heat dissipation fins that are attached to the heat dissipation substrate and rotate together with the heat dissipation substrate by causing a cooling medium to pass therethrough.

A projector according to an embodiment of the disclosure includes a light source apparatus that is provided with a light conversion device and a light source section that emits excitation light toward the light conversion device, and an image generating section that generates an image on a basis of light emitted from the light source apparatus. The light conversion device includes a heat dissipation substrate having a surface that is provided with a phosphor, and a plurality of heat dissipation fins that are attached to the heat dissipation substrate and rotate together with the heat dissipation substrate by causing a cooling medium to pass therethrough.

In the light conversion device, the light source apparatus, or the projector according to the embodiment of the disclosure, the heat dissipation substrate rotates together with the plurality of heat dissipation fins by causing the cooling medium to pass therethrough.

According to the light conversion device, the light source apparatus, or the projector of the embodiment of the disclosure, the heat dissipation substrate rotates together with the plurality of heat dissipation fins by causing the cooling medium to pass therethrough, thus allowing for cooling of heat generated in the phosphor without a motor.

It is to be noted that the effects described here are not necessarily limitative, and may be any of effects described in the disclosure.

### BRIEF DESCRIPTION OF DRAWINGS

FIG. 1 is a configuration diagram illustrating an example of a projector according to a first embodiment of the disclosure.

FIG. 2 is a configuration diagram illustrating an example of a light source apparatus according to the first embodiment.

FIG. 3 is a cross-sectional view of a configuration example of a main part of a light conversion device according to the first embodiment.

FIG. 4 is an external view of a configuration example of a main part of the light conversion device according to the first embodiment.

FIG. 5 is an explanatory diagram illustrating an example of an air-blowing direction of cooling air in the light conversion device according to the first embodiment.

FIG. 6 is an explanatory diagram illustrating an example in which the air-blowing direction is set to be opposite to the direction in the example illustrated in FIG. 5.

FIG. 7 is an explanatory diagram illustrating an example in which the air-blowing direction illustrated in FIG. 5 is set at upper side of a main shaft as viewed from a direction in which the main shaft is attached.

FIG. 8 is an explanatory diagram illustrating an example in which the air-blowing direction illustrated in FIG. 5 is set at lower side of the main shaft as viewed from the direction in which the main shaft is attached.

FIG. 9 is an external view of an example in which a Sirocco fan is disposed in the light conversion device according to the first embodiment.

FIG. 10 is a top view of the example in which the Sirocco fan is disposed in the light conversion device according to the first embodiment.

FIG. 11 is an explanatory diagram illustrating an example of air-blowing directions of streams of cooling air in a light conversion device according to a second embodiment.

FIG. 12 is an explanatory diagram illustrating a first example of the air-blowing directions of the streams of cooling air as viewed from a direction in which the main shaft is attached in the light conversion device according to the second embodiment.

FIG. 13 is an explanatory diagram illustrating a second example of the air-blowing directions of the streams of cooling air as viewed from the direction in which the main shaft is attached in the light conversion device according to the second embodiment.

FIG. 14 is an external view of an example in which the Sirocco fan is disposed in the light conversion device according to the second embodiment.

FIG. 15 is a top view of the example in which the Sirocco fan is disposed in the light conversion device according to the second embodiment.

FIG. 16 is a cross-sectional view of a modification example of a heat sink.

FIG. 17 is an external view of a configuration example of a main part of a light conversion device according to a third embodiment.

FIG. 18 is an explanatory diagram illustrating an example of an air-blowing direction of cooling air in the light conversion device according to the third embodiment.

FIG. 19 is an explanatory diagram illustrating an example in which the air-blowing direction illustrated in FIG. 18 is set at upper side of the main shaft as viewed from the direction in which the main shaft is attached.

FIG. 20 is an external view of an example in which the Sirocco fan is disposed in the light conversion device according to the third embodiment.

FIG. 21 is a top view of the example in which the Sirocco fan is disposed in the light conversion device according to the third embodiment.

FIG. 22 is an explanatory diagram illustrating an example of air-blowing directions of streams of cooling air in a light conversion device according to a fourth embodiment.

FIG. 23 is an explanatory diagram illustrating an example of the air-blowing directions of the streams of cooling air as viewed from the direction in which the main shaft is attached in the light conversion device according to the fourth embodiment.

FIG. 24 is an external view of an example in which the Sirocco fan is disposed in the light conversion device according to the fourth embodiment.

FIG. 25 is a top view of the example in which the Sirocco fan is disposed in the light conversion device according to the fourth embodiment.

FIG. 26 is an external view of a configuration example of a main part of a light conversion device according to a fifth embodiment.

FIG. 27 is a side view of the configuration example of the main part of the light conversion device according to the fifth embodiment.

FIG. 28 is a top view of the configuration example of the main part of the light conversion device according to the fifth embodiment.

FIG. 29 is an explanatory diagram illustrating an example of a light conversion device according to another embodiment.

### MODES FOR CARRYING OUT THE INVENTION

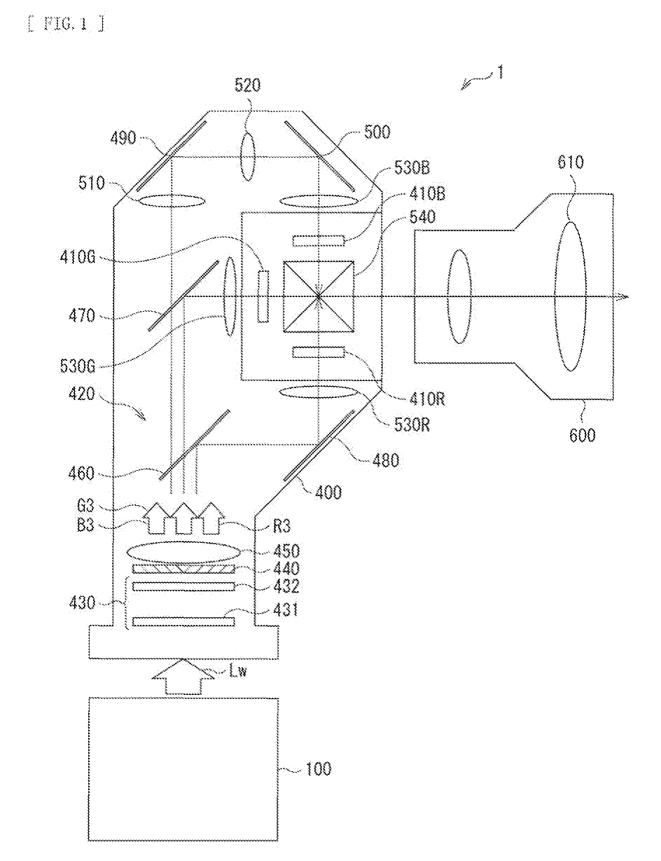

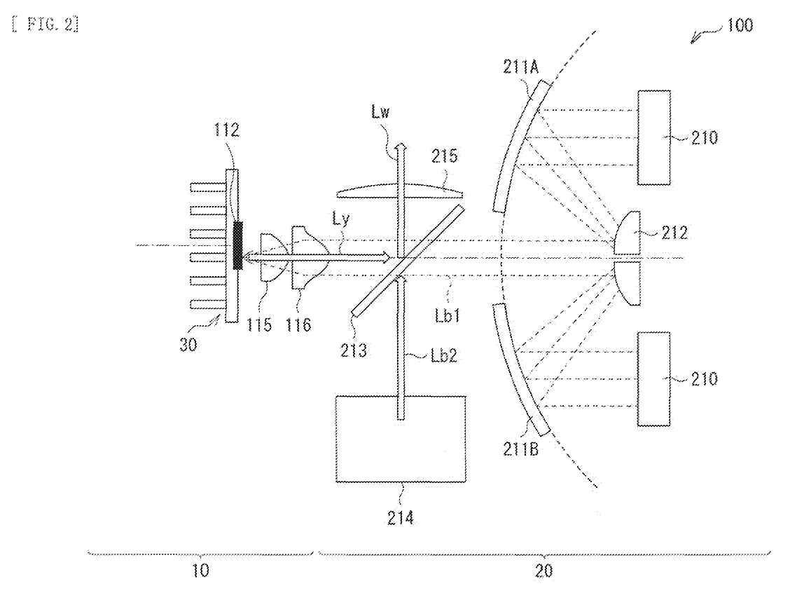

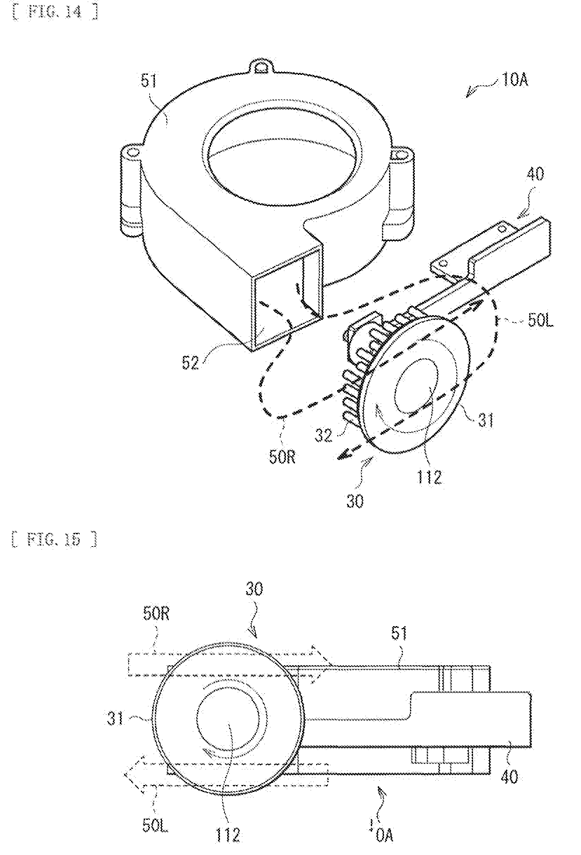

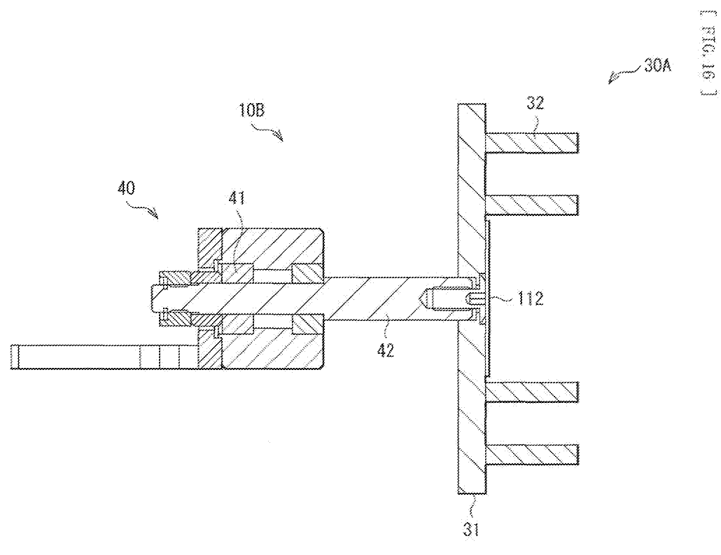

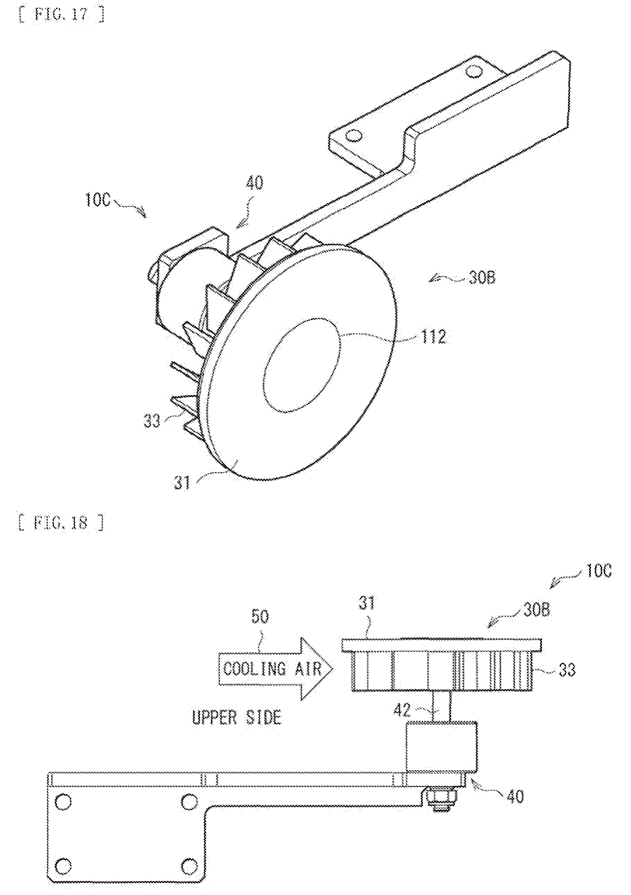

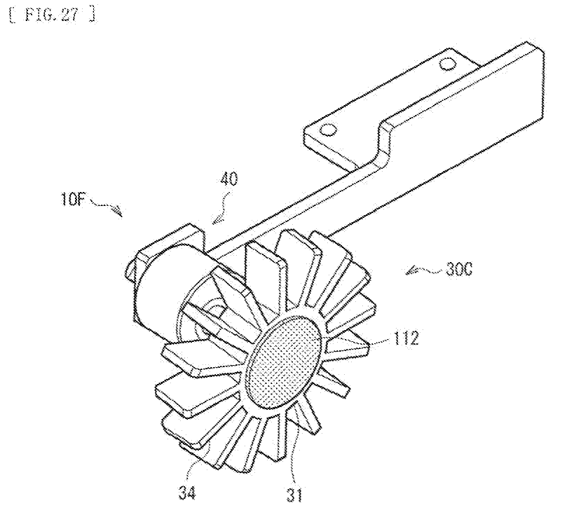

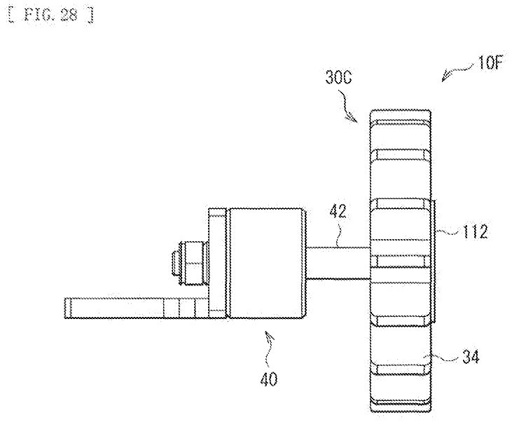

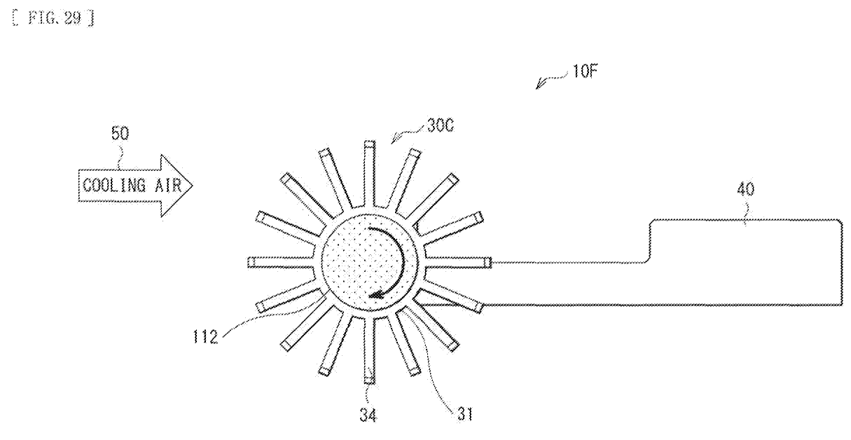

In the following, some embodiments of the disclosure are described in detail with reference to drawings. It is to be noted that description is given in the following order.
1. First Embodiment
   1.1 Configuration
      1.1.1 Configuration Example of Projector (FIG. 1)
      1.1.2 Configuration Example of Light Source Apparatus (FIG. 2)
      1.1.3 Configuration Example of Light Conversion Device (Cylindrical Fins, One-Side Air-Blowing System) (FIGS. 3 to 10)
   1.2 Workings and Effects
2. Second Embodiment (Cylindrical Fins, Two-Side Air-Blowing System)
   2.1 Configuration Example of Light Conversion Device (FIGS. 11 to 15)
   2.2 Workings and Effects
   2.3 Modification Example of Heat Sink (FIG. 16)
3. Third Embodiment (Impeller Fins, One-Side Air-Blowing System) (FIGS. 17 to 21)
4. Fourth Embodiment (Impeller Fins, Perpendicular Air-Blowing System) (FIGS. 22 to 25)
5. Fifth Embodiment (An example in which heat dissipation fins are radially provided) (FIGS. 26 to 28)
6. Other Embodiments

### 1. First Embodiment

### [1.1 Configuration]

### (1.1.1 Configuration Example of Projector)

FIG. 1 illustrates a configuration example of a projector according to a first embodiment of the disclosure. A projector 1 according to the present embodiment includes a light source apparatus 100, an image generating system 400 that generates an image on the basis of light emitted from the light source apparatus 100, and a projection optical system 600. The image generating system 400 includes an image generating section that generates an image on the basis of irradiation light, and an illumination optical system 420 that irradiates the image generating section with the light emitted from the light source apparatus 100.

The image generating section includes a red light valve 410R, a green light valve 410G, a blue light valve 410B, and a dichroic prism 540 that synthesizes pieces of light from the respective light valves 410R, 410G, and 410B. The light valves 410R, 410G, and 410B are each configured by a transmissive liquid crystal display element, for example.

The projection optical system 600 projects the image generated in the image generating section onto an unillustrated screen, and includes a plurality of lenses 610.

The illumination optical system 420 includes an integrator element 430, a polarization conversion element 440, a condensing lens 450, dichroic mirrors 460 and 470, mirrors 480, 490, and 500, relay lenses 510 and 520, and field lenses 530R, 530G, and 530B.

The integrator element 430 includes a first fly-eye lens 431 and a second fly-eye lens 432. The first fly-eye lens 431 includes, for example, a plurality of microlenses that are arrayed two-dimensionally. The second fly-eye lens 432 includes, for example, a plurality of microlenses that are arrayed to correspond to the respective microlenses of the first fly-eye lens 431.

The integrator element 430 has a function of arranging the incident light, from the light source apparatus 100, with which the polarization conversion element 440 is irradiated so as to have a uniform luminance distribution as a whole. The light incident on the integrator element 430 from the light source apparatus 100 is, for example, parallel light of white light Lw. The parallel light from the light source apparatus 100 is split into a plurality of light fluxes by the plurality of microlenses of the first fly-eye lens 431. The split light fluxes form respective images on the corresponding microlenses of the second fly-eye lens 432. Each of the plurality of microlenses of the second fly-eye lens 432 functions as a secondary light source. The polarization conversion element 440 is irradiated with the pieces of parallel light, as incident light, having matched luminance from the plurality of microlenses of the second fly-eye lens 432

The polarization conversion element 440 has a function of causing the pieces of incident light that have been incident through the integrator element 430 to have a matched polarization state. The condensing lens 450 outputs ongoing light including blue light B3, green light G3, and red light R3 thorough the polarization conversion element 440.

The dichroic mirrors 460 and 470 each have a property of selectively reflecting color light of a predetermined wavelength region and transmitting pieces of light of other wavelength regions. For example, the dichroic mirror 460 selectively reflects the red light R3. The dichroic mirror 470 selectively reflects the green light G3 out of the green light G3 and the blue light B3 that have been transmitted through the dichroic mirror 460. The remaining blue light B3 is transmitted through the dichroic mirror 470. This causes the white light Lw emitted from the light source apparatus 100 is split into pieces of color light of different colors.

The split red light R3 is reflected by the mirror 480, is collimated by passing through the field lens 530R, and then enters the light valve 410R for modulation of the red light R3. The green light G3 is collimated by passing through the field lens 530G, and then enters the light valve 410G for modulation of the green light G3. The blue light B3 passes through the relay lens 510 and is reflected by the mirror 490, then further passes through the relay lens 520, and is reflected by the mirror 500. The blue light B3 that has been reflected by the mirror 500 is collimated by passing through the field lens 530B, and then enters the light valve 410B for modulation of the blue light B3.

The light valves 410R, 410G, and 410B are each electrically coupled to a signal source of an unillustrated image reproducer, for example, that supplies an image signal including image information. The light valves 410R, 410G, and 410B each modulate pieces of the incident light pixel by pixel on the basis of the supplied image signals of respective colors to generate images of the respective colors. In other words, the light valve 410R generates a red image. The light valve 410G generates a green image. The light valve 410B generates a blue image. Pieces of modulated image light of respective colors enter the dichroic prism 540 and are synthesized together. The dichroic prism 540 superposes and synthesizes together the pieces of image light of the respective colors that have been incident from three directions, and outputs the synthesized pieces of light toward the projection optical system 600.

The projection optical system 600 irradiates an unillustrated screen with the image light synthesized by the dichroic prism 540. This allows a full-color image to be displayed.

### (1.1.2 Configuration Example of Light Source Apparatus)

FIG. 2 illustrates a configuration example of the light source apparatus 100.

The light source apparatus 100 includes a light conversion device 10 and a light source section 20 that emits excitation light toward the light conversion device. The light source section 20 includes a light source 210, condensing mirrors 211A, 211B, and 212, a dichroic mirror 213, a blue light source optical system 214, and a condensing lens 215.

The light conversion device 10 includes condensing lenses 115 and 116, and a heat sink 30 having a surface where a phosphor 112 is formed that is excited by the excitation light. The condensing lens 115 condenses the excitation light that has been incident through the condensing lens 116 onto the phosphor 112. Further, the condensing lens 115 outputs a fluorescent component from the phosphor 112 toward the condensing lens 116. The condensing lens 116 condenses the excitation light from the light source section 20 toward the condensing lens 115. Further, the condensing lens 116 condenses the fluorescent component from the phosphor 112 that has been incident through the condensing lens 115 toward the light source section 20. It is to be noted that although FIG. 2 illustrates a configuration example in which two condensing lenses are adopted in the light conversion device 10, this is not limitative; three or more condensing lenses may also be adopted. Further, the structure of the heat sink 30 is described in detail later.

The light source 210 is configured, for example, by a blue LD that is able to oscillate blue light Lb1 having a peak wavelength of emission intensity within a wavelength range ranging from 400 nm to 500 nm, for example. The blue light source optical system 214 also includes, for example, the blue LD that is able to oscillate blue light Lb2. Any other light source such as LED may be used, aside from the LD, for the light source 210 and the blue light source optical system 214.

The condensing mirrors 211A, 211B, and 212 constitute an optical system that outputs, as the excitation light, the blue light Lb1 emitted from the light source 210 toward the light conversion device 10.

The blue light source optical system 214 emits the blue light Lb2 to be synthesized with yellow light Ly outputted from the light conversion device 10 to generate the white light Lw. The dichroic mirror 213 and the condensing lens 215 constitute an optical system that synthesizes the yellow light Ly and the blue light Lb2 to generate the white light Lw, and outputs the generated white light Lw to the outside.

The condensing mirrors 211A and 211B each have a concave reflective surface that substantially collimates light fluxes of the blue light Lb1 emitted from the light source 210 and concentrates them on the condensing mirror 212. The condensing mirror 212 reflects the blue light Lb1 concentrated by the condensing mirrors 211A and 211B toward the light conversion device 10.

The dichroic mirror 213 has a property of selectively reflecting color light of a predetermined wavelength region and transmitting pieces of light of other wavelength regions. Specifically, the dichroic mirror 213 transmits the blue light Lb1 emitted from the light source 210 and the blue light Lb2 emitted from the blue light source optical system 214, and reflects the yellow light Ly having undergone light conversion from the blue light Lb1 in the light conversion device 10.

The blue light Lb1 having been transmitted through the dichroic mirror 213 irradiates the phosphor 112 through the condensing lenses 115 and 116 in the light conversion device 10 to thereby excite the phosphor 112. The excited phosphor 112 converts, for example, the blue light Lb1 being the excitation light into the yellow light Ly of a wavelength region including a red wavelength region to a green wavelength region as the fluorescent component. The yellow light Ly is reflected by the dichroic mirror 213 toward the condensing lens 214. Further, the blue light Lb2 emitted from the blue light source optical system 214 is transmitted through the dichroic mirror 213 toward the condensing lens 214. The blue light Lb2 and the yellow light Ly are synthesized to thereby generate the white light Lw.

### (1.1.3 Configuration Example of Light Conversion Device)

### (Basic Configuration of Main Part of Light Conversion Device 10)

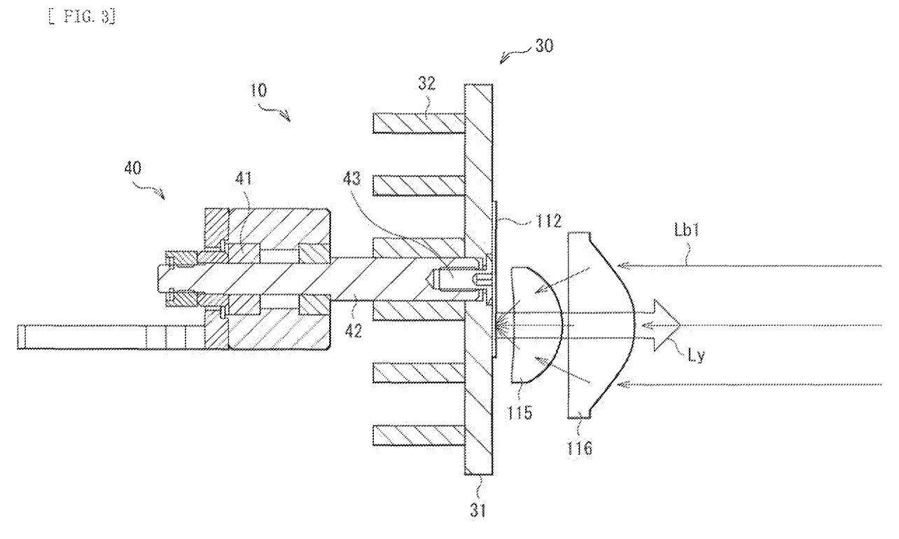

FIGS. 3 and 4 each illustrate a configuration example of a main part of the light conversion device 10.

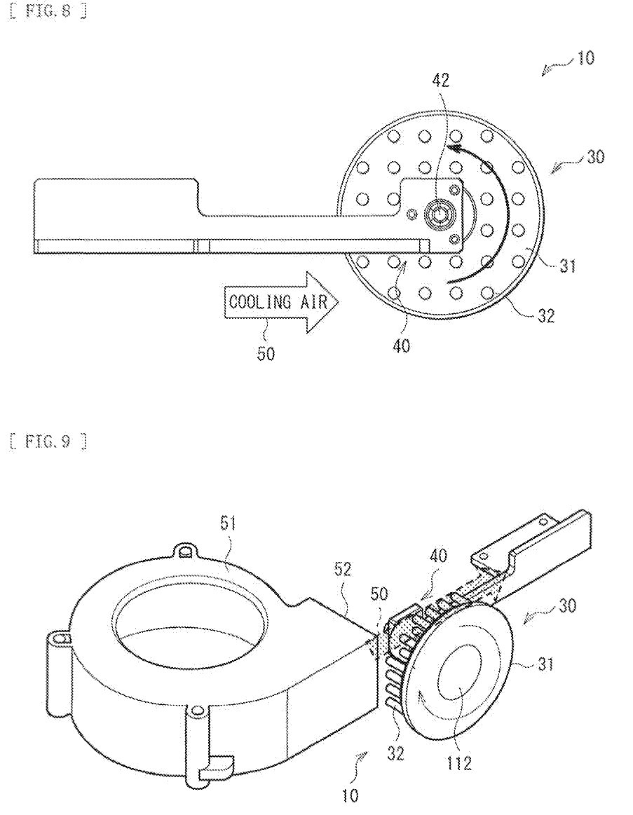

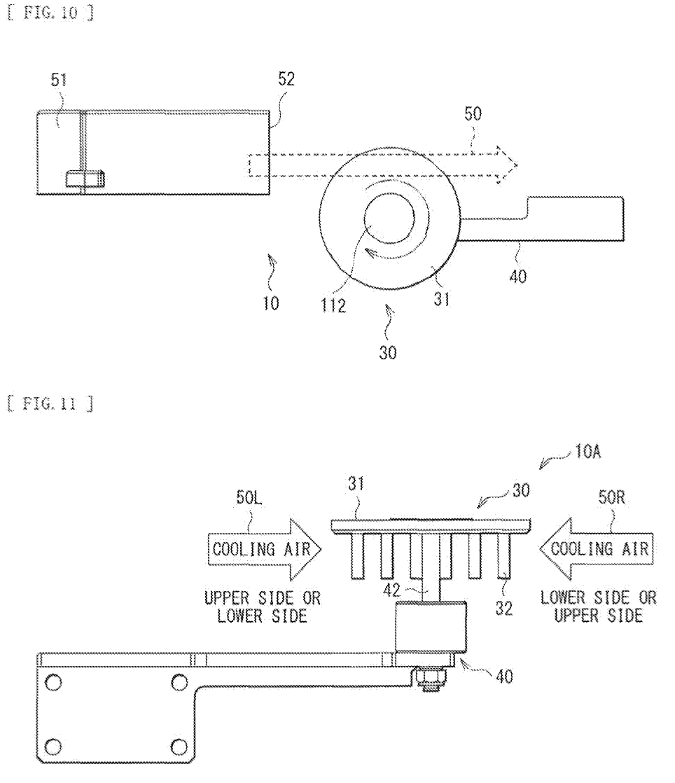

The light conversion device 10 includes the heat sink 30 as a heat dissipation member having the surface provided with the phosphor 112, and a bearing unit 40 attached to the heat sink 30. Further, the light conversion device 10 includes a Sirocco fan 51 as a blower, as illustrated in FIGS. 9 and 10 to be described later.

The heat sink 30 includes a disc section 31 in a disc shape as a heat dissipation substrate having the surface that is provided with the phosphor 112. Further, the heat sink 30 includes a plurality of cylindrical fins 32 as heat dissipation fins that are attached to the disc section 31 and rotate together with the disc section 31 by causing a cooling medium to pass therethrough. The cylindrical fins 32 are attached to a surface (bottom surface), of the disc section 31, opposite to the surface that is provided with the phosphor 112.

The disc section 31 and the cylindrical fins 32 have a function of diffusing heat generation of the phosphor 112 to lower the temperature. The cylindrical fins 32 have a function of conducting the heat diffused by the disc section 31 to the air to dissipate the heat. The cylindrical fin 32 and the disc section 31 are each made of, for example, a material having relatively high thermal conductivity, such as aluminum, copper, an aluminum-silicon carbide composite material (Al—SiC), sapphire, and molybdenum.

The bearing unit 40 includes a main shaft 41 attached to a center part of the disc section 31 via a bolt 43 on rear surface side thereof, and a bearing 42 that rotationally holds the main shaft 41. The bearing unit 40 desirably has a configuration that is adaptable to a usage environment. In a case where heat resistance is necessary, for example, it is desirable to have a configuration in which heat resistant grease is sealed in a part of the bearing 42. Further, in a case where an outgas is used as a cooling medium, it is desirable to have a configuration in which low dust generation grease is sealed. Further, the part of the bearing 42 may be a rubber-sealed type as a precaution against dust.

The phosphor 112 is provided at the center part of the disc section 31, for example. The phosphor 112 may be formed on the disc section 31 with an unillustrated adhesive layer interposed therebetween. Further, an unillustrated reflective layer may be formed on a surface of the phosphor 112. Furthermore, in a case where a transparent adhesive layer (having high transmittance) is used, an unillustrated reflective layer may be formed between the phosphor 112 and the disc section 31.

The phosphor 112 is excited by the blue light Lb1 being the excitation light from the light source section 20 to emit light of a wavelength region that is different from the wavelength of the excitation light. The phosphor 112 contains a phosphor material that generates fluorescence by being excited by the blue light Lb1 having a center wavelength of about 445 nm, for example, and converts a portion of the blue light Lb1 into the yellow light Ly to output it as the fluorescent component. As the phosphor material contained in the phosphor 112, for example, a yttrium-aluminum-garnet (YAG)-based phosphor is used. It is to be noted that there is no limitation on the types of the phosphor material, the wavelength region of light to be excited, and the wavelength region of visible light that is generated by the excitation.

The phosphor 112 is a solid being a polycrystal or a sintered body that converts a wavelength of the excitation light. The phosphor 112 may be, for example, a powdered phosphor material applied to a substrate. Alternatively, the phosphor 112 may be a phosphor material solidified with an inorganic material. Alternatively, the phosphor 112 may be a phosphor material processed with a crystalline material, or a sintered phosphor material. A form of the phosphor 112 is not limited to those described above insofar as the phosphor 112 has a function of converting the wavelength into a wavelength different from that of the excitation light.

It is to be noted that, in order to diffuse heat density by rotation of the phosphor 112, the blue light Lb1 being the excitation light desirably irradiates a location, in the phosphor 112, that is off the central axis of the rotation, as illustrated in FIG. 3. It is more desirable to irradiate a location as close to an outer circumference as possible. For example, it is desirable to irradiate outer circumferential side than an intermediate position between the central axis of the rotation and the outer circumference of the phosphor 112.

### (Example of Rotation of Heat Sink 30)

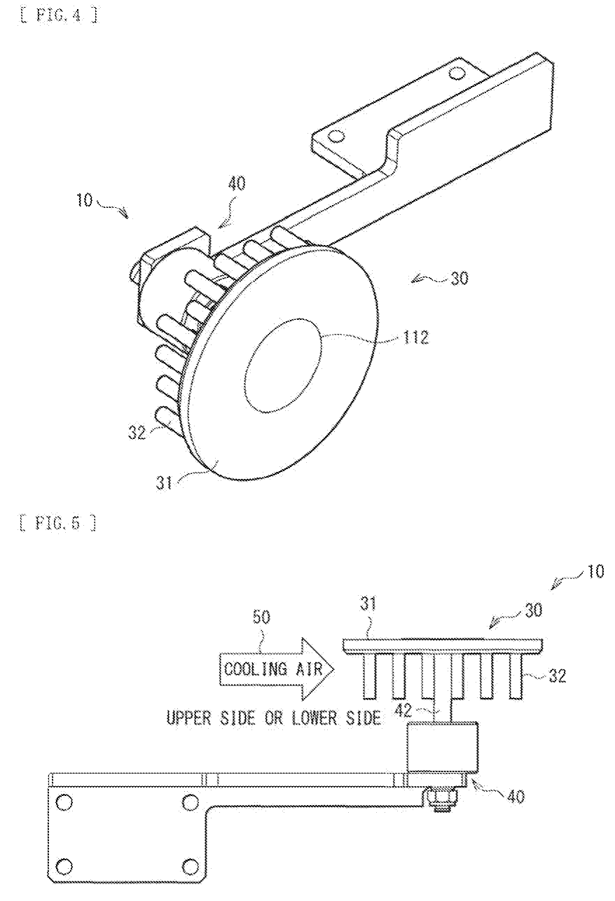

In the light conversion device 10, the heat sink 30 rotates around a main shaft 42 of the bearing unit 40 as a rotation center by causing a cooling medium to pass through the cylindrical fins 32. Description is given below of an example of the rotation of the heat sink 30, with reference to FIGS. 5 to 10. In the present embodiment, description is given of a case, as an example, where cooling air 50 sent from the Sirocco fan 51 is used as the cooling medium.

FIG. 5 illustrates an example of an air-blowing direction of the cooling air 50. FIG. 6 illustrates an example in which the air-blowing direction is set to be opposite to the direction in the example illustrated in FIG. 5. As illustrated in FIG. 5 or 6, the cooling air 50 is blown to the cylindrical fins 32, for example, from a certain single direction, as viewed from a direction orthogonal to the direction in which the main shaft 42 is attached. In this case, the cooling air 50 may be blown from upper side or from lower side of the main shaft 42, when viewed from a direction in which the main shaft 42 is attached.

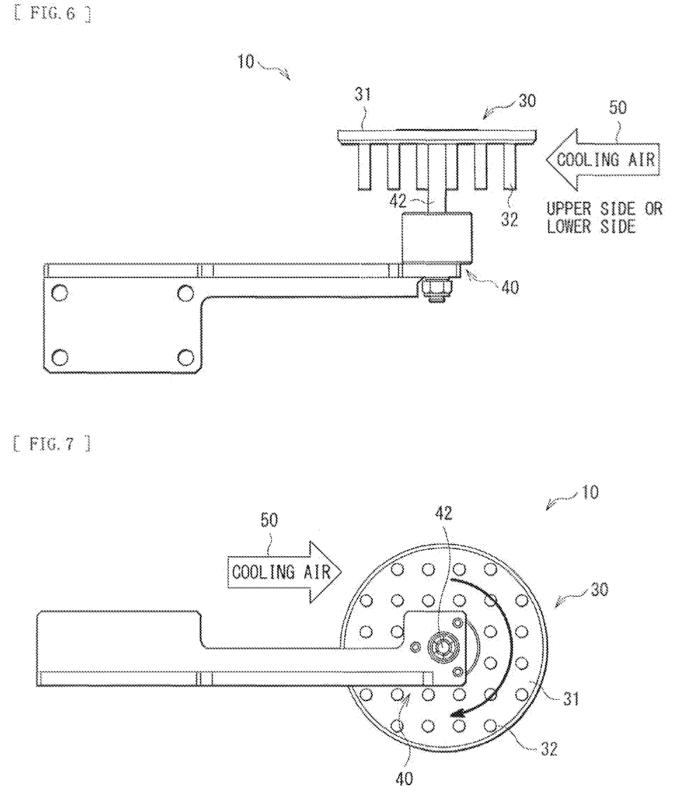

FIG. 7 illustrates an example in which the air-blowing direction illustrated in FIG. 5 is set at upper side of the main shaft 42 as viewed from the direction in which the main shaft 42 is attached. FIG. 8 illustrates an example in which the air-blowing direction illustrated in FIG. 5 is set at lower side of the main shaft 42 as viewed from the direction in which the main shaft 42 is attached.

FIGS. 9 and 10 each illustrate an example in which the Sirocco fan 51 is disposed in the light conversion device 10. FIGS. 9 and 10 each illustrate an example in which the air-blowing direction is set at upper side of the main shaft 42 as viewed from the direction in which the main shaft 42 is attached. In this case, for example, on side where the cylindrical fins 32 are attached, a blower outlet 52 of the Sirocco fan 51 is disposed on upper side of the main shaft 42. It is to be noted that an unillustrated blower duct or exhaust duct may be provided in order to blow the cooling air 50 to the cylindrical fins 32 efficiently.

In this manner, in the present embodiment, the Sirocco fan 51 sends the cooling air 50 to the cylindrical fins 32 from upper side or lower side to the main shaft 42 when viewed from the direction in which the main shaft 42 is attached. Accordingly, the disc section 31 and the cylindrical fins 32 rotate by causing the cooling air 50 to pass through the cylindrical fins 32 located on upper side or lower side of the main shaft 42 when viewed from the direction in which the main shaft 42 is attached.

### (Example of Rotational Control of Heat Sink 30)

A rotational control as described below may be performed upon power activation of the light conversion device 10. First, it is desirable to set a fan voltage of the Sirocco fan 51 at a state of a rated voltage and to maintain the state of the rated voltage until the heat sink 30 is in a stable rotation state so as to have a high air volume, because torque is necessary the most when the heat sink 30 is started to rotate. It is desirable to lower the fan voltage of the Sirocco fan 51 and thus to decrease the air volume thereafter to allow the phosphor 112 to have a predetermined temperature. The heat sink 30 may be provided with, for example, a protector function that lowers the fan voltage in a case of exceeding predetermined number of rotations by providing a sensor that detects the number of rotations. In addition, a sensor such as an air speed sensor and a pneumatic sensor may be provided as necessary.

Further, a rotational control as described below may be performed in accordance with usage environments such as an ambient temperature and an atmospheric pressure. For example, in a case of high ambient temperature, it is desirable to perform a voltage control that increases the fan voltage of the Sirocco fan 51 or to perform PWM control that increases the number of fan rotations thereof to increase the air volume of the fan for reinforcement of cooling. Moreover, in a case of low atmospheric pressure, for example, in a case of a highland, thin air lowers a cooling capability. Therefore, it is desirable to increase the air volume to reinforce the cooling capability as with the case of high ambient temperature. In this case, it is desirable to provide the pneumatic sensor in order to detect the atmospheric pressure automatically.

### [1.3 Workings and Effects]

As described above, according to the present embodiment, the disc section 31 rotates together with the plurality of cylindrical fins 32 by causing the cooling air 50 to pass therethrough, thus allowing for cooling of heat generated in the phosphor 112 without a motor.

According to the present embodiment, the heat sink 30 has a mechanism of rotating when the cooling air 50 reaches the cylindrical fins 30 of the heat sink 30, thus allowing for both rotation and cooling of the heat sink 30 without a motor.

The present embodiment allows for the structure in which the main shaft 42 is held by the bearing 41 without using a motor, thus leading to a long life and a strong structure even against dust. Further, it is possible to alleviate the weight limitation of the heat sink 30 as compared with the case of using the motor. Furthermore, no use of a motor leads to no generation of an unusual high-frequency noise from the motor, thus allowing for more quiet sound.

It is to be noted that the effects described herein are merely examples and are not necessarily limitative; the effects may further include other effects. The same holds true also for other following embodiments.

### 2. Second Embodiment

Description is given next of a second embodiment of the disclosure. Description is omitted below, where appropriate, for a part having a configuration and a working similar to those of the foregoing first embodiment.

### (2.1 Configuration Example of Light Conversion Device)

Basic configurations of a light conversion device 10A according to the present embodiment may be substantially similar to those of the light conversion device 10 according to the foregoing first embodiment except the location where the Sirocco fan 51 is disposed and the air-blowing direction of the cooling medium by the Sirocco fan 51.

Further, configurations of a projector and a light source apparatus according to the present embodiment may be substantially similar to those of the foregoing first embodiment except the configuration of the light conversion device 10A.

In the present embodiment, the Sirocco fan 51 sends cooling air 50L (or cooling air 50R) from a first direction (left side or right side) to the cylindrical fins 32 located on upper side of the main shaft 42 when viewed from the direction in which the main shaft 42 of the bearing unit 40 is attached. Further, the Sirocco fan 51 sends the cooling air 50R (or the cooling air 50L) from a second direction (right side or left side), a direction opposite to the first direction, to the cylindrical fins 32 located on lower side. This causes the cooling air 50L (or the cooling air 50R) to pass through the cylindrical fins 32 located on upper side of the main shaft 42 from the first direction when viewed from the direction in which the main shaft 42 is attached. Further, the cooling air 50R (or the cooling air 50L) passes through the cylindrical fins 32 located on lower side of the main shaft 42 from the second direction, a direction opposite to the first direction. This causes the disc section 31 and the cylindrical fins 32 to rotate.

FIG. 11 illustrates an example of air-blowing directions of the cooling air 50L and the cooling air 50R as viewed from a direction orthogonal to the direction in which the main shaft 42 is attached. As illustrated in FIG. 11, streams of the cooling air 50L and the cooling air 50R are blown to the cylindrical fins 32 from the right and left directions, as viewed from the direction orthogonal to the direction in which the main shaft 42 is attached. Further, in each of the right and left directions, the air-blowing directions of the cooling air 50L and the cooling air 50R are allowed to be different from each other in upper direction and lower direction, as viewed from the direction in which the main shaft 42 is attached.

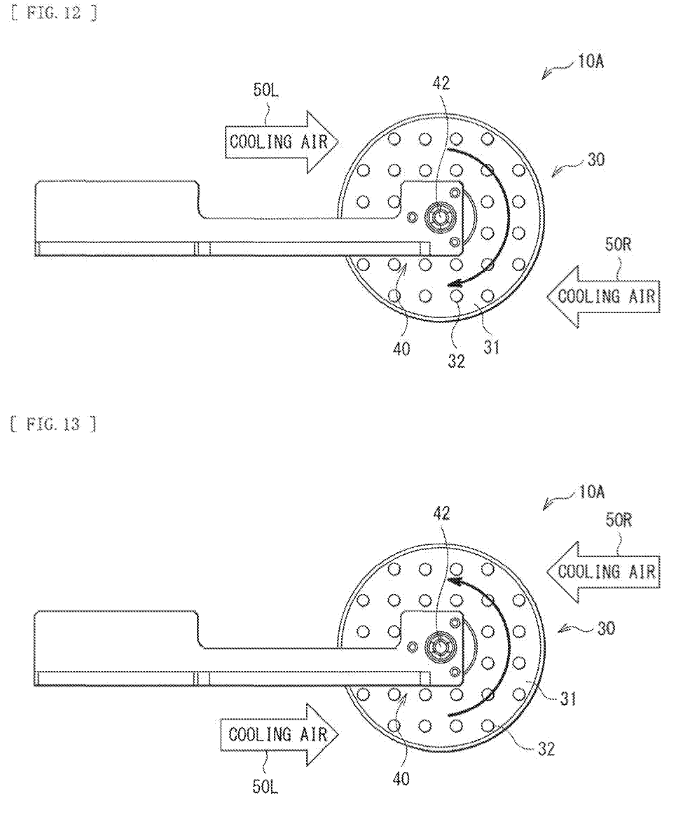

FIG. 12 illustrates a first example of the air-blowing directions of the cooling air 50L and the cooling air 50R as viewed from the direction in which the main shaft 42 is attached. FIG. 13 illustrates a second example of the air-blowing directions of the cooling air 50L and the cooling air 50R as viewed from the direction in which the main shaft 42 is attached. In the first example of FIG. 12, the cooling air 50L is blown to the cylindrical fins 32 from the left direction on upper side of the main shaft 42, whereas the cooling air 50R is blown to the cylindrical fins 32 from the right direction on lower side of the main shaft 42. In the second example of FIG. 13, the cooling air 50L is blown to the cylindrical fins 32 from the left direction on lower side of the main shaft 42, whereas the cooling air 50R is blown to the cylindrical fins 32 from the right direction on upper side of the main shaft 42.

FIGS. 14 and 15 each illustrate an example in which the Sirocco fan 51 is disposed in the light conversion device 10A. For example, on side where the cylindrical fins 32 are attached, the blower outlet 52 of the Sirocco fan 51 is disposed in a direction same as that of the main shaft 42. It is to be noted that an unillustrated blower duct or exhaust duct may be provided in order to blow the streams of the cooling air 50L and the cooling air 50R to the cylindrical fins 32 efficiently.

### (2.2 Workings and Effects)

The present embodiment allows for the structure in which the streams of the cooling air 50L and the cooling air 50R are blown to the cylindrical fins 32 from the right and left directions on upper and lower sides, thus facilitating increase in the number of rotations of the heat sink 30, which enables the cooling capability to be enhanced.

### (2.3 Modification Example of Heat Sink)

FIG. 16 illustrates a configuration example of a light conversion device 10B according to a modification example of the present embodiment. The light conversion device 10B according to the present modification example includes a heat sink 30A instead of the heat sink 30 in the light conversion devices 10 and 10A according to the foregoing first and second embodiments.

The light conversion devices 10 and 10A according to the foregoing first and second embodiments each represent the configuration example in which the cylindrical fins 32 are provided on side opposite to the surface where the phosphor 112 is formed in the heat sink 30. In contrast, in the light conversion device 10B according to the present modification example, the cylindrical fins 32 are provided on side of the surface same as the surface where the phosphor 112 is formed in the heat sink 30A.

The location where the Sirocco fan 51 is disposed and the air-blowing direction by the Sirocco fan 51 may be appropriately adjusted in a manner corresponding to the location where the cylindrical fins 32 are provided.

Other basic configurations may be substantially similar to those of the light conversion devices 10 and 10A according to the foregoing first and second embodiments.

Further, the configurations of a projector and a light source apparatus according to the present modification example may be substantially similar to those of the foregoing first embodiment except the configuration of the light conversion device 10B.

### 3. Third Embodiment

Description is given next of a third embodiment of the disclosure. Description is omitted below, where appropriate, for a part having a configuration and a working similar to those of the foregoing first embodiment or the foregoing second embodiment.

FIG. 17 illustrates a configuration example of a main part of a light conversion device 10C according to a third embodiment. The light conversion device 10C according to the present embodiment includes a heat sink 30B instead of the heat sink 30 in the light conversion device 10 according to the foregoing first embodiment. The heat sink 30B includes impeller fins 33 instead of the cylindrical fins 32 in the foregoing first embodiment. Other basic configurations may be substantially similar to those of the light conversion device 10 according to the foregoing first embodiment.

Further, the configurations of a projector and a light source apparatus according to the present embodiment may be substantially similar to those of the foregoing first embodiment except the configuration of the light conversion device 10C.

In the light conversion device 10C, the heat sink 30B rotates around the main shaft 42 of the bearing unit 40 as a rotation center by causing a cooling medium to pass through the impeller fins 33. Description is given below of an example of the rotation of the heat sink 30B, with reference to FIGS. 18 to 21. In the present embodiment, description is given of a case, as an example, where the cooling air 50 sent from the Sirocco fan 51 is used as the cooling medium.

FIGS. 18 and 19 each illustrate an example of an air-blowing direction of the cooling air 50 in the light conversion device 10C. As illustrated in FIGS. 18 and 19, the cooling air 50 is blown to the impeller fins 33, for example, from a certain single air-blowing direction, as viewed from a direction orthogonal to the direction in which the main shaft 42 is attached. In this case, the cooling air 50 is blown from upper side of the main shaft 42, for example, as viewed from the direction in which the main shaft 42 is attached. It is to be noted that the cooling air 50 may also be blown from lower side.

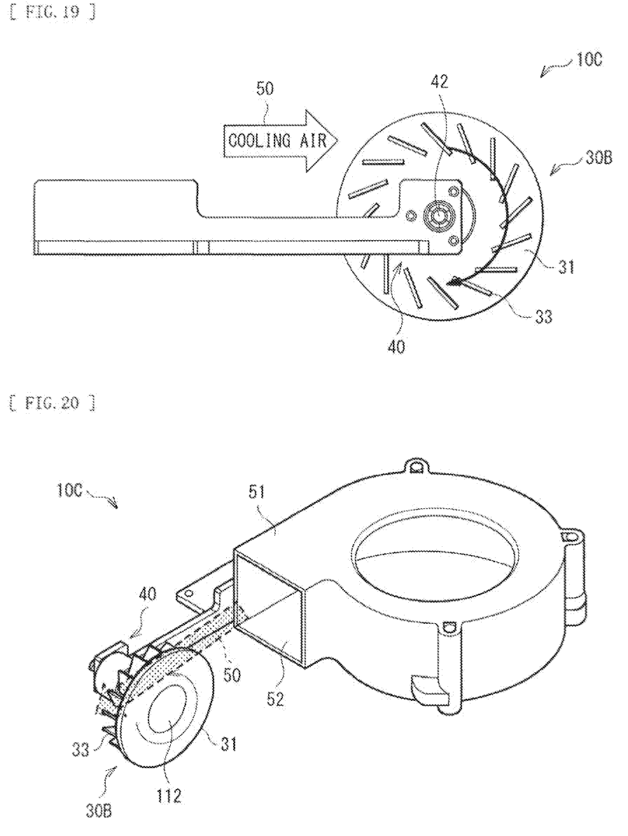

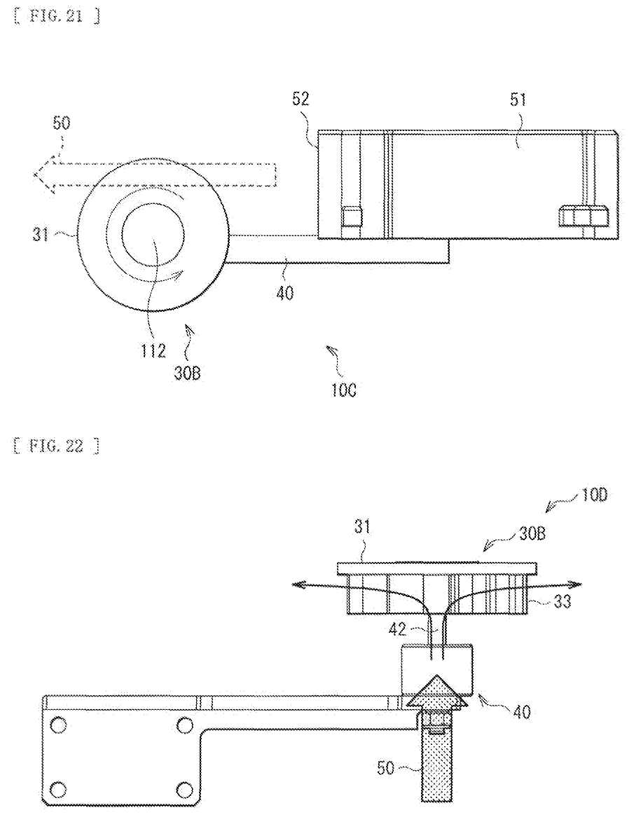

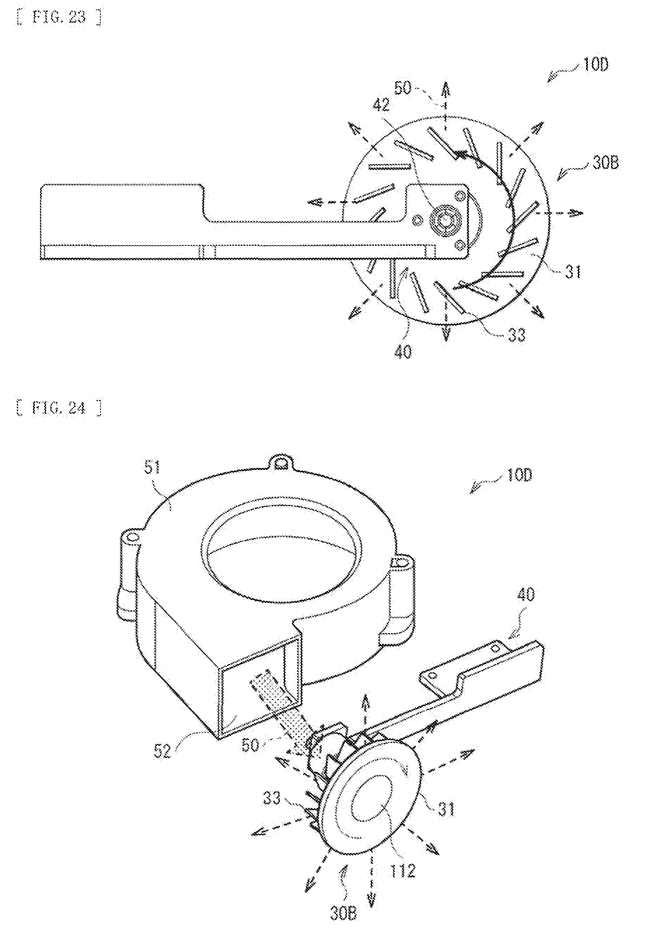

FIGS. 20 and 21 each illustrate an example in which the Sirocco fan 51 is disposed in the light conversion device 10C. FIGS. 20 and 21 each illustrate an example in which the air-blowing direction is set at upper side of the main shaft 42 as viewed from the direction in which the main shaft 42 is attached. In this case, for example, on side where the impeller fins 33 are attached, the blower outlet 52 of the Sirocco fan 51 is disposed on upper side of the main shaft 42. It is to be noted that an unillustrated blower duct or exhaust duct may be provided in order to blow the cooling air 50 to the impeller fins 33 efficiently.

In this manner, in the present embodiment, the Sirocco fan 51 sends the cooling air 50 to the impeller fins 33 from upper side or lower side to the main shaft 42 when viewed from the direction in which the main shaft 42 is attached. Accordingly, the disc section 31 and the impeller fins 33 rotate by causing the cooling air 50 to pass through the impeller fins 33 located on upper side or lower side of the main shaft 42 when viewed from the direction in which the main shaft 42 is attached.

### 4. Fourth Embodiment

Description is given next of a fourth embodiment of the disclosure. Description is omitted below, where appropriate, for a part having a configuration and a working similar to those of the foregoing first to third embodiments.

Basic configurations of a light conversion device 10D according to the present embodiment may be substantially similar to those of the light conversion device 10C according to the foregoing third embodiment except the location where the Sirocco fan 51 is disposed and the air-blowing direction of the cooling medium by the Sirocco fan 51.

Further, the configurations of a projector and a light source apparatus according to the present embodiment may be substantially similar to those of the foregoing first embodiment except the configuration of the light conversion device 10D.

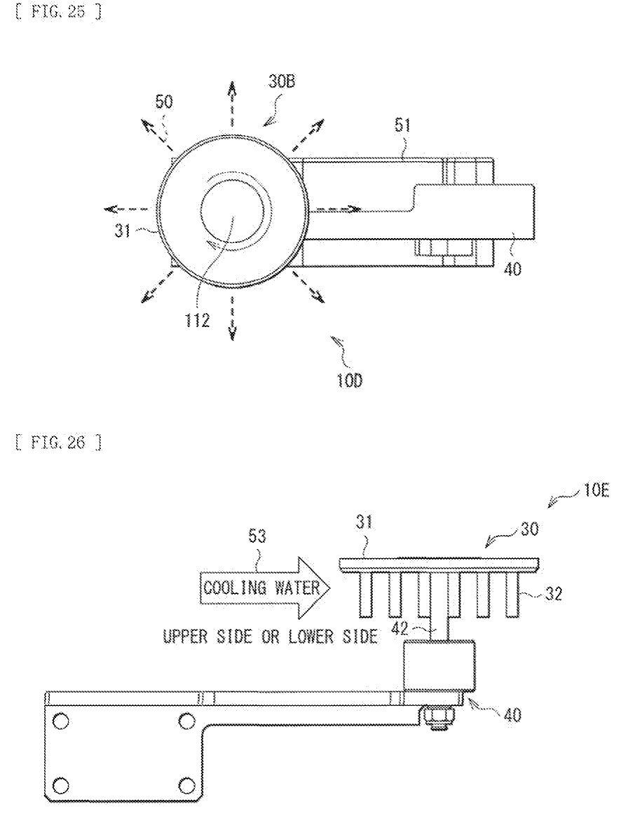

FIG. 22 illustrates an example of an air-blowing direction of the cooling air 50 in the light conversion device 10D according to the present embodiment, as viewed from a direction orthogonal to the direction in which the main shaft 42 is attached. FIG. 23 illustrates an example of the air-blowing direction of the cooling air 50 as viewed from the direction in which the main shaft 42 of the bearing unit 40 is attached. FIGS. 24 and 25 each illustrate an example in which the Sirocco fan 51 is disposed in the light conversion device 10D.

In the present embodiment, the Sirocco fan 51 sends the cooling air 50 to the impeller fins 33 from a direction same as the direction in which the main shaft 42 is attached, when viewed from the direction in which the main shaft 42 of the bearing unit 40 is attached. This causes the cooling air 50 to be sent to the impeller fins 33 from the direction same as the direction in which the main shaft 42 is attached, and causes the cooling air 50 to pass through the plurality of impeller fins 33 radially, when viewed from the direction in which the main shaft 42 is attached, thereby causing the impeller fins 33 to rotate.

### 5. Fifth Embodiment

Description is given next of a fifth embodiment of the disclosure. Description is omitted below, where appropriate, for a part having a configuration and a working similar to those of the foregoing first to fourth embodiments.

FIGS. 26 to 28 each illustrate a configuration example of a main part of a light conversion device 10F according to a fifth embodiment.

In the light conversion devices according to the foregoing first to fourth embodiments, the heat dissipation fins (cylindrical fins 33 or impeller fins 33) are provided on the surface, of the disc section 31, where the phosphor 112 is formed or on the surface opposite to the surface where the phosphor 112 is formed. In contrast, the light conversion device 10F according to the present embodiment includes a heat sink 30C provided with heat dissipation fins 34 radially on an outer circumference of the disc section 31. Substantially similarly to the light conversion device 10 according to the foregoing first embodiment, for example, the light conversion device 10F allows for rotation of the heat sink 30C by blowing the cooling air 50 to the heat dissipation fins 34 from upper side or lower side of the main shaft 42 of the bearing unit 40. Further, substantially similarly to the light conversion device 10A according to the foregoing second embodiment, for example, the heat sink 30C may be rotated by blowing the streams of the cooling air 50L and the cooling air 50R to the heat dissipation fins 34 from both upper side and lower side of the main shaft 42 of the bearing unit 40. It is to be noted that FIG. 29 illustrates an example in which the cooling air 50 is blown to the heat dissipation fins 34 from upper side of the main shaft 42.

Other basic configurations may be substantially similar to those of the light conversion devices according to the foregoing first and fourth embodiments.

Further, the configurations of a projector and a light source apparatus according to the present embodiment may be substantially similar to those of the foregoing first embodiment except the configuration of the light conversion device 10F.

### 6. Other Embodiments

The technique according to the present disclosure is not limited to the description of the foregoing each embodiment, and various modifications may be made.

For example, the location where the phosphor 112 is formed in the light conversion device is not limited to the center part of the disc section 31 of each of the heat sinks 30, 30A, and 30B; any other location may be adopted. For example, the phosphor 112 may be formed in a ring-shaped manner at a location distant from the center part of the disc section 31.

Further, although each of the foregoing embodiments illustrate the example of the reflective configuration of the light conversion device, a transmissive configuration may also be adopted. In this case, it is possible to generate the white light Lw by synthesis of the yellow light Ly being the phosphor component by the phosphor 112 and the blue light Lb1 having been transmitted through the phosphor 112. In this case, the use of the blue light Lb1 to be transmitted through the phosphor 112 makes it possible to eliminate the blue light source optical system 214 and the dichroic mirror 213 of the light source section 20 from the configuration of FIG. 2, thus allowing for miniaturization of the light source section 20. Further, in the case of adopting the transmissive configuration, the location of the main shaft 42 of the bearing unit 40, the location of the phosphor 112, etc. may be appropriately adjusted to allow the light transmitted through the phosphor 112 to be utilized in an optical system in a subsequent stage.

Furthermore, description has been given, in each of the foregoing embodiments, of the example in which an air-cooling system is employed in the light conversion device; however, liquid may also be used as the cooling medium instead of the cooling air 50, the cooling air 50L, and the cooling air 50R to rotate each of the heat sink 30, 30A, and 30B. As illustrated in FIG. 29, for example, a liquid-cooling system in which cooling water 53 is used as the cooling medium may be employed to rotate the heat sink 30. In this case, a bearing material in the bearing unit 40 is desirably resin or ceramic.

Moreover, the technique according to the present disclosure is not only limited to the projector, but is also applicable to a vehicle headlight and special illumination, for example.

For example, the present technology may have the following configurations.
(1)

A light conversion device including:

a heat dissipation substrate having a surface that is provided with a phosphor; and

a plurality of heat dissipation fins that are attached to the heat dissipation substrate, and rotate together with the heat dissipation substrate by causing a cooling medium to pass therethrough.
(2)

The light conversion device according to (1), in which the plurality of heat dissipation fins are attached to a surface, of the heat dissipation substrate, that is provided with the phosphor, a surface opposite to the surface that is provided with the phosphor, or an outer circumference of the heat dissipation substrate.
(3)

The light conversion device according to (1) or (2), further including a bearing unit having a main shaft attached to a center part of the heat dissipation substrate.
(4)

The light conversion device according to (3), further including a fan that sends the cooling medium to the heat dissipation fins from upper side or lower side of the main shaft when viewed in a direction in which the shaft is attached.
(5)

The light conversion device according to (3), further including a fan that sends the cooling medium from a first direction to the heat dissipation fins located on upper side of the main shaft when viewed in a direction in which the shaft is attached, and sends the cooling medium from a second direction opposite to the first direction to the heat dissipation fins located on lower side.
(6)

The light conversion device according to (3), further including a fan that sends the cooling medium to the heat dissipation fins from a direction same as a direction in which the shaft is attached when viewed in the direction in which the shaft is attached.
(7)

The light conversion device according to any one of (1) to (5), in which the heat dissipation fins include cylindrical fins.
(8)

The light conversion device according to (7), in which the cylindrical fins are attached orthogonally to a surface, of the heat dissipation substrate, that is provided with the phosphor, or to a surface opposite to the surface that is provided with the phosphor.
(9)

The light conversion device according to any one of (1) to (4) and (6), in which the heat dissipation fins include impeller fins.
(10)

The light conversion device according to any one of (1) to (9), in which the heat dissipation substrate has a disc shape.
(11)

The light conversion device according to any one of (1) to (10), in which the phosphor is provided at a center part of the heat dissipation substrate.
(12)

A light source apparatus including:

a light conversion device; and

a light source section that emits excitation light toward the light conversion device, the light conversion device including

a heat dissipation substrate having a surface that is provided with a phosphor, and

a plurality of heat dissipation fins that are attached to the heat dissipation substrate, and rotate together with the heat dissipation substrate by causing a cooling medium to pass therethrough.
(13)

A projector including:

a light source apparatus that is provided with a light conversion device and a light source section that emits excitation light toward the light conversion device; and

an image generating section that generates an image on a basis of light emitted from the light source apparatus, the light conversion device including

a heat dissipation substrate having a surface that is provided with a phosphor, and

a plurality of heat dissipation fins that are attached to the heat dissipation substrate, and rotate together with the heat dissipation substrate by causing a cooling medium to pass therethrough.

This application is based upon and claims priority from Japanese Patent Application No. 2015-099921 filed with the Japan Patent Office on May 15, 2015, the entire contents of which are hereby incorporated by reference.

It should be understood by those skilled in the art that various modifications, combinations, sub-combinations, and alterations may occur depending on design requirements and other factors insofar as they are within the scope of the appended claims or the equivalents thereof.

1. A light conversion device comprising:
a heat dissipation substrate having a surface that is provided with a phosphor; and
a plurality of heat dissipation fins that are attached to the heat dissipation substrate, and rotate together with the heat dissipation substrate by causing a cooling medium to pass therethrough.

2. The light conversion device according to claim 1, wherein the plurality of heat dissipation fins are attached to a surface, of the heat dissipation substrate, that is provided with the phosphor, a surface opposite to the surface that is provided with the phosphor, or an outer circumference of the heat dissipation substrate.

3. The light conversion device according to claim 1, further comprising a bearing unit having a main shaft attached to a center part of the heat dissipation substrate.

4. The light conversion device according to claim 3, further comprising a fan that sends the cooling medium to the heat dissipation fins from upper side or lower side of the main shaft when viewed in a direction in which the shaft is attached.

5. The light conversion device according to claim 3, further comprising a fan that sends the cooling medium from a first direction to the heat dissipation fins located on upper side of the main shaft when viewed in a direction in which the shaft is attached, and sends the cooling medium from a second direction opposite to the first direction to the heat dissipation fins located on lower side.

6. The light conversion device according to claim 3, further comprising a fan that sends the cooling medium to the heat dissipation fins from a direction same as a direction in which the shaft is attached when viewed in the direction in which the shaft is attached.

7. The light conversion device according to claim 1, wherein the heat dissipation fins comprise cylindrical fins.

8. The light conversion device according to claim 7, wherein the cylindrical fins are attached orthogonally to a surface, of the heat dissipation substrate, that is provided with the phosphor, or to a surface opposite to the surface that is provided with the phosphor.

9. The light conversion device according to claim 1, wherein the heat dissipation fins comprise impeller fins.

10. The light conversion device according to claim 1, wherein the heat dissipation substrate has a disc shape.

11. The light conversion device according to claim 1, wherein the phosphor is provided at a center part of the heat dissipation substrate.

12. A light source apparatus comprising:
a light conversion device; and
a light source section that emits excitation light toward the light conversion device, the light conversion device including
a heat dissipation substrate having a surface that is provided with a phosphor, and
a plurality of heat dissipation fins that are attached to the heat dissipation substrate, and rotate together with the heat dissipation substrate by causing a cooling medium to pass therethrough.

13. A projector comprising:
a light source apparatus that is provided with a light conversion device and a light source section that emits excitation light toward the light conversion device; and
an image generating section that generates an image on a basis of light emitted from the light source apparatus, the light conversion device including
a heat dissipation substrate having a surface that is provided with a phosphor, and
a plurality of heat dissipation fins that are attached to the heat dissipation substrate, and rotate together with the heat dissipation substrate by causing a cooling medium to pass therethrough.
